(19) United States
(12) Patent Application Publication
(10) Pub. No.: US 2002/0178049 A1
(43) Pub. Date: Nov. 28, 2002

(54) System and method and interface for evaluating a supply base of a supply chain

(76) Inventor: Jonathan Bye, Surrey (GB)

Correspondence Address: BANNER & WITCOFF, 1001 G STREET N W, SUITE 1100, WASHINGTON, DC, 20001, US

(21) Appl. No.: 09/864,383

(22) Filed: May 25, 2001

(51) Int. Cl. G06F 17/60

(52) U.S. Cl. 705/11

(57) ABSTRACT

A system, method and interface for evaluating the supply base of a supply chain. The system, method and interface facilitate the collation of information in a supplier database. The system, method and interface facilitate the evaluation of a base of suppliers forming a supply base of a supply chain. The evaluation includes providing a database of information relating to supplier performance and capabilities based on historical performance. The supply base evaluation system, method and interface can be used to qualify and disqualify suppliers, and to improve supplier performance and capabilities. Objective feedback may be provided to suppliers, the feedback including metrics captured and tracked by the system. Development plans may be implemented to improve the manner in which suppliers do business throughout the supply chain.

### BACKGROUND OF THE INVENTION

1. Field of the Invention

The present invention relates to a system, method and interface for evaluating the supply base of a supply chain. More particularly, the present invention relates to a system, method and interface for facilitating the evaluation of a base of suppliers forming a supply base for a supply chain. The evaluation entails providing a database of supplier performance and capabilities based on historical performance. The supply base evaluation system, method and interface of the present invention can be used to qualify and disqualify suppliers, and to improve supplier performance and capabilities.

2. Description of the Prior Art

The channels that goods or resources travel through are known as a supply chain. These channels may extend from a manufacturing point to a retail sales location or from a point where a resource, such as raw ore, is harvested to a manufacturing location, where a product is made from that resource. In the manufacturing process or sales process, over-supply or under-supply of goods or resources is undesirable. An efficient supply chain maintains the optimum amount of goods and resources throughout the supply chain to avoid both overstocking and under-stocking.

In conventional supply chains it is difficult to assess the performance and capabilities of a supplier to find a supplier that can meet a retailer or manufacturer's needs. While a retailer, for instance, can contact a better business bureau to learn if complaints have been filed against a supplier, such information is anecdotal and not quantifiable. Furthermore, a better business bureau would only maintain negative information and not positive information, historical performance, or capabilities for a supplier. Consequently, the information available at a service such as a better business bureau is of limited utility.

In order to perform long term planning it would be very useful to members of a supply chain to be able to determine the performance and capabilities of a supplier and thereby better-forecast sales, inventories, replenishment intervals, seasonal variations, etc.

### SUMMARY OF THE INVENTION

Advantageously, the system, method and interface for evaluating the supply base of a supply chain in accordance with embodiments of the present invention can provide a qualitative assessment of a supplier's capabilities and characteristics, comprehensive assessments of a supplier's historical performance and a way to evaluate the risks and benefits associated with working with supplier during sourcing decisions.

The system, method and interface for evaluating the supply base of a supply chain according to the present invention can identify gaps and surplus in a supplier database. An interface facilitates the collation of information in the supplier database. Cross functional opportunities can be found using a supplier database and an interface screens, which will potentially capture information on what products are produced by each supplier.

Suppliers that fail to meet minimum standards may be removed from the database, and thus from the supply chain. In conjunction with the removal of a supplier from the database, objective feedback may be provided to suppliers, the feedback including metrics captured and tracked by the system. Removal of a supplier from the supply chain should therefore come as no surprise to the suppliers, as they will have visibility of how their performance is perceived via the rankings and metrics. Potential new suppliers may be evaluated and added to the supplier database if they meet measured service levels. Similarly, suppliers may be able provide information to the system of their increased capacities and capabilities.

Proactive development plans may be implemented to improve the manner in which suppliers do business throughout the supply chain and thereby maintain high ratings. The information in the database is updated regularly to help to monitor supplier's performance.

### BRIEF DESCRIPTION OF THE DRAWINGS

These and other attributes of the present invention will be described with respect to the following drawings in which:

FIG. 1 is a block diagram illustrating a computer system upon which the system and method of the present invention may be embodied;

FIG. 2 is a flow chart illustrating activities and responsibilities involved in managing and maintaining the supplier database using the system, method and interface for evaluating the supply base of a supply chain according to the present invention;

FIG. 3 is a block diagram illustrating flow between interface screens according to the system, method and interface for evaluating the supply base of a supply chain of the present invention;

FIG. 4 is a logon screen for the system, method and interface for evaluating the supply base of a supply chain according to the present invention;

FIG. 5 is a home page screen for the system, method and interface for evaluating the supply base of a supply chain according to the present invention;

FIG. 6 is an actuals evaluation screen according to the present invention;

FIG. 7 is a supplier information screen according to the present invention;

FIG. 8 is a teams view evaluation screen according to the present invention;

FIG. 9 is bulletin board screen according to the present invention;

FIG. 10 is an actuals comparison screen according to the present invention;

FIG. 11 is a trend evaluation screen according to the present invention;

FIG. 12 is a teams view comparison screen according to the present invention;

FIG. 13 is a trend evaluation screen according to the present invention;

FIG. 14 is screen for linking a supplier to a specific product type, according to the present invention;

FIG. 15 is a screen showing suppliers ranked by their team scores according to the present invention; and

FIG. 16 is a flow chart of the method according to the present invention.

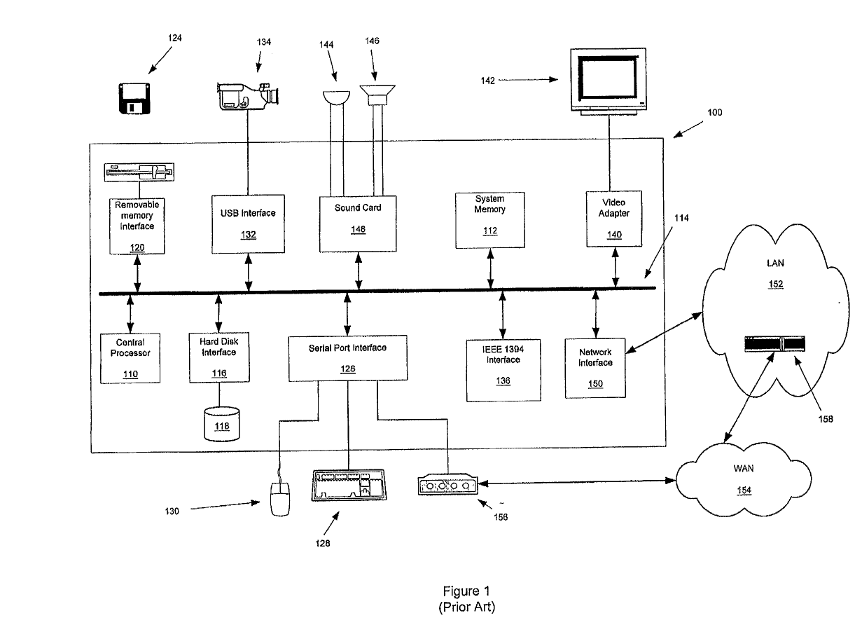

### DETAILED DESCRIPTION OF THE INVENTION

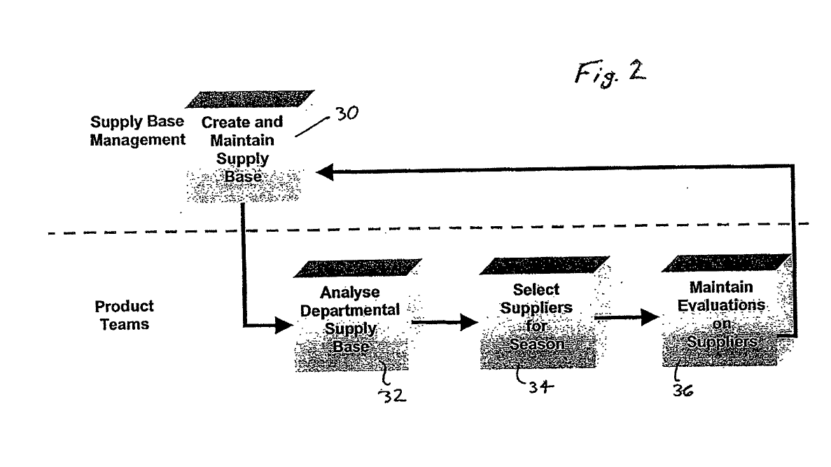

The present invention may be embodied on a computer system, such as the system 100 shown in FIG. 2. Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of w removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 2 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 2 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 2 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 2 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 2 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

Referring to the flow chart shown in FIG. 2, activities and responsibilities involved in managing and maintaining the supplier database are outlined using the system, method and interface for evaluating the supply base of a supply chain according to the present invention. The flow chart, shown in FIG. 2, includes the step 30 of creating and maintaining a database of suppliers. The information in the database is used to analyze departmental databases of suppliers in step 32. The results of the analysis of step 32 is utilized in step 34 the select suppliers for each season. The results of the selections made in step 34 are tracked to develop evaluations of suppliers is step 36. The evaluations of suppliers, developed in step 36, are in turn utilized to maintain the database of suppliers in step 30.

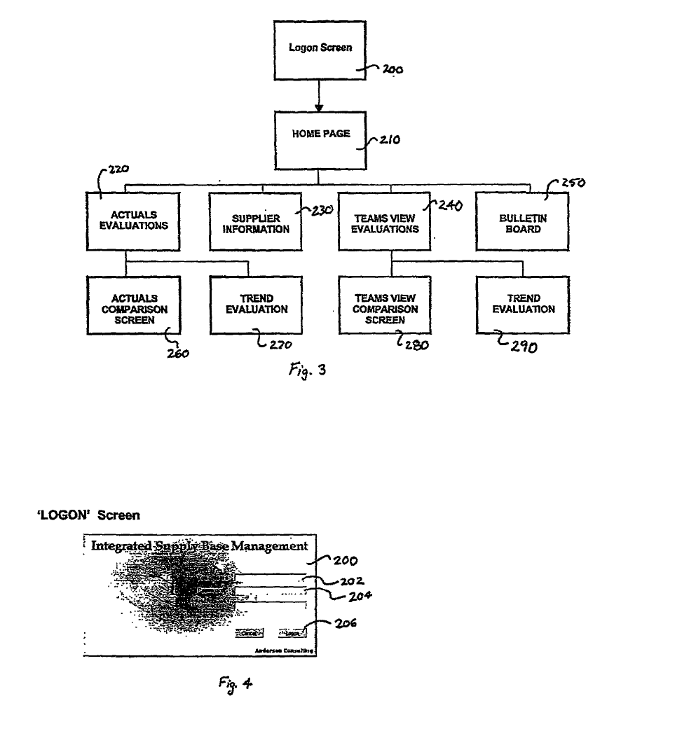

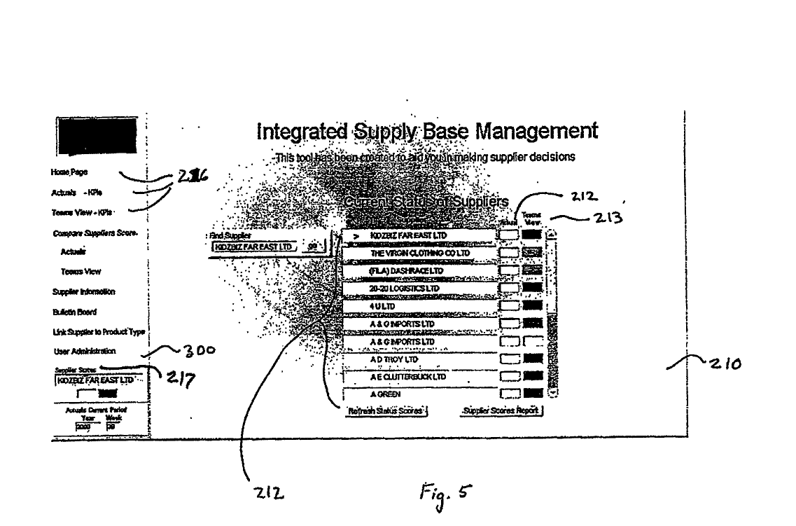

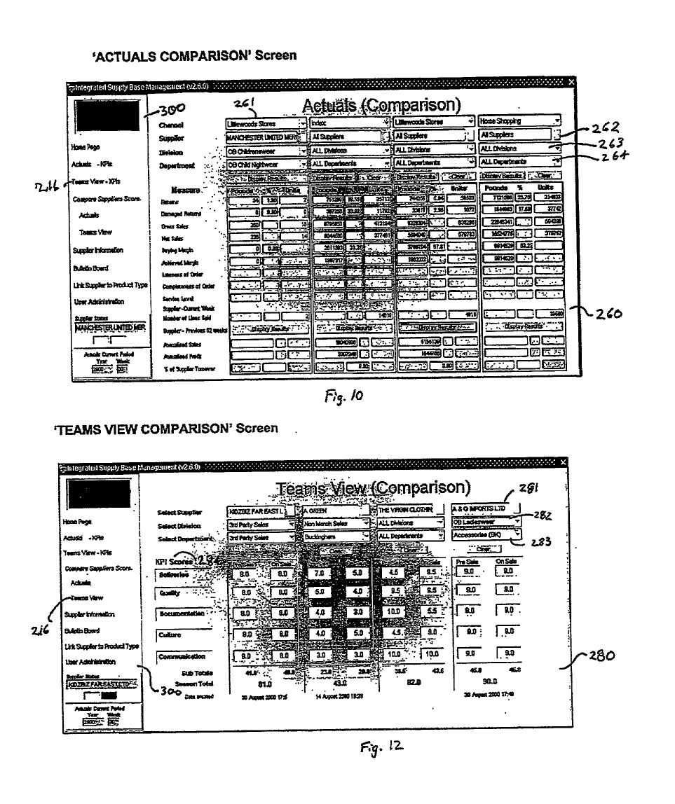

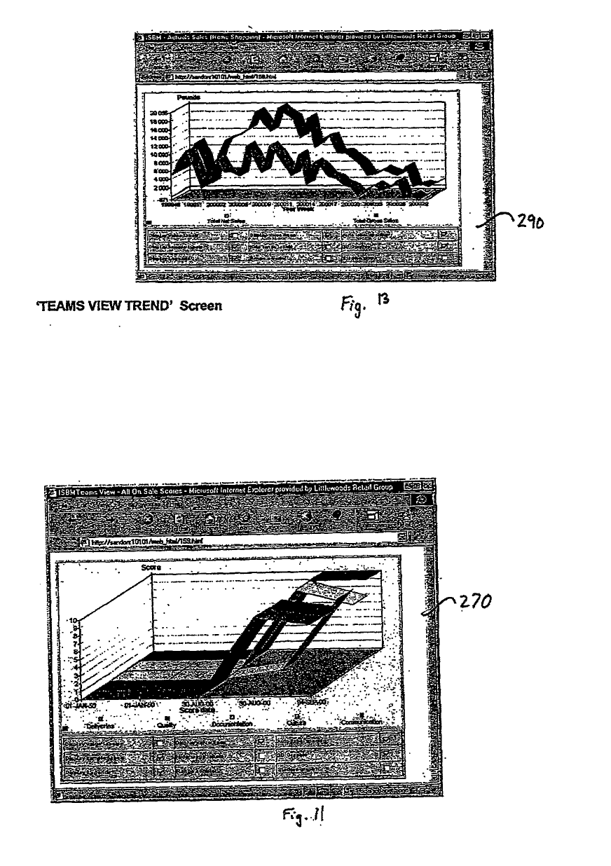

The system, method and interface for evaluating the supply base of a supply chain according to the present invention displays a number of screens on a display, such as the display device 142 of the computer system 100. FIG. 3 illustrates a logical order in which these screens may be reviewed. In particular, the interface of the present invention begins with a logon screen 200, shown in FIG. 4, described in detail below. After successfully logging on, a user is presented with the home page screen 210, shown in FIG. 5. From the home page screen 210, a user can select from: an actuals evaluation screen 220, a supplier information screen 230, a teams view evaluation screen 240, and a bulletin board 250, shown in FIGS. 6-9, respectively, actuals comparison screen 260 shown in FIG. 10, or teams view comparison screen 280, shown in FIG. 12, and described in detail below.

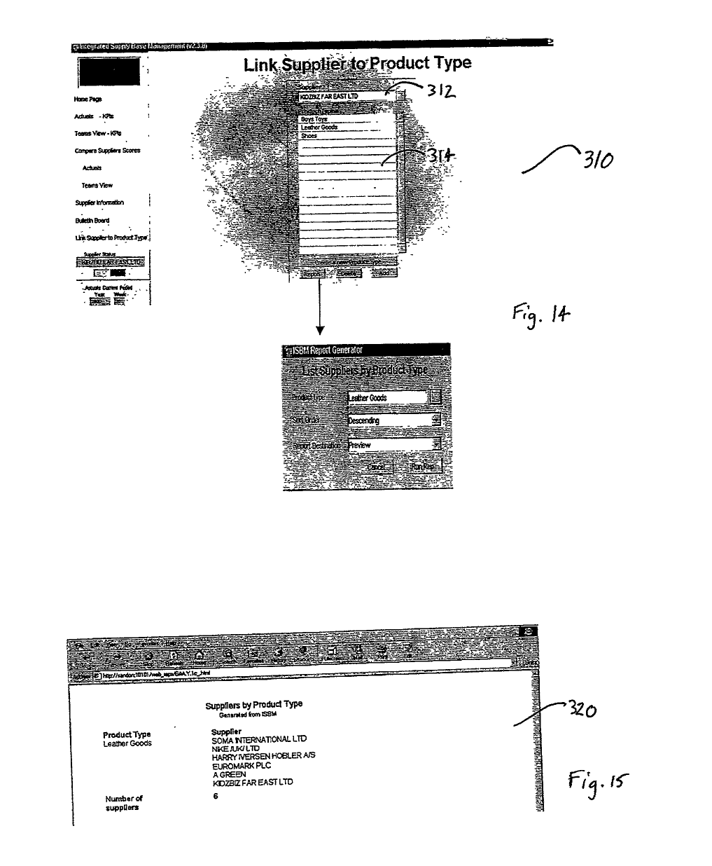

From the actuals evaluation screen 220, a user can select a trend evaluation screen 270 shown in FIG. 11. A user can select a trend evaluation screen 290, shown in FIG. 13 from the teams view evaluation screen 240.

Referring to FIG. 4, when a user first begins to use the system of the present invention, the interface displays the logon screen 200. Users are requested to enter their user ID into field 202 along with their password in field 204 on the logon screen 200. Upon successful logon, achieved by selecting logon button 206, most users will only have authorization to read information and no permission to enter information. In one embodiment, only users that are members of the quality assurance team (QA) will have write access to the system in order to maintain accurate assessments of the suppliers. Most users will be authorized to read all information in the application, but will have no write access. Once QA members launch the application they may be required to follow the same procedure for logging on, however they will be allowed to edit scores on the Teams View screen, described in detail below. Administrative users may be allowed to review, reject or submit Bulletin Board messages, input Supplier Turnover and Websites, add or delete product type or add or delete users.

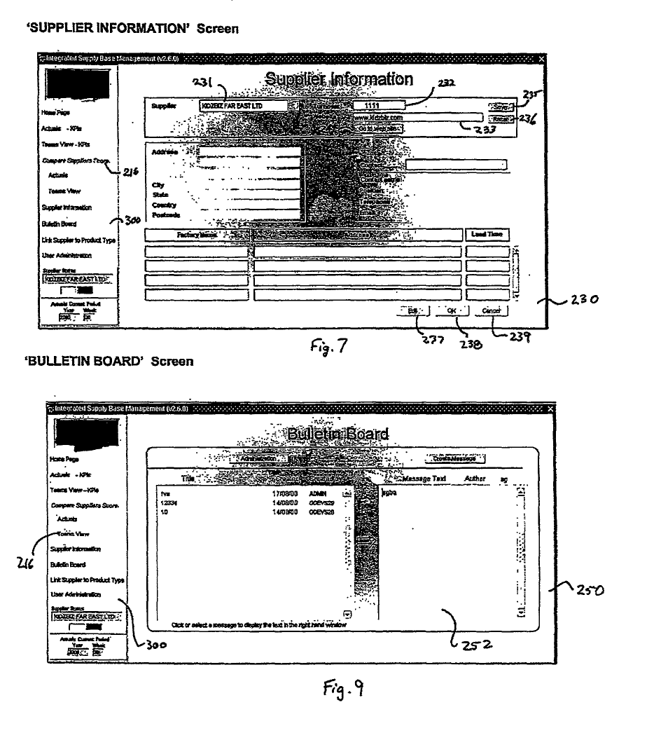

Each user's permissions are established with the establishment of their account, and will be invisible to the user. The ID and password entered in the logon screen 200 will determine the level of user access to the information in the system. Members of the QA team will be allowed to edit scores in the team view evaluation screen 240, discussed below. All users will be allowed to post messages on the bulletin board screen 250, shown in FIG. 9.

Successful logon through screen 200 brings up the homepage screen 210, shown in FIG. 5. The homepage screen 210 is a web page containing a list of suppliers 211 with corresponding status ratings. The status ratings include actuals 212 and team views 213. The actuals 212 displays the status for each supplier based on actuals information from the actuals evaluation screen 220. Similarly, the teams view fields 213 display the status (red, green or amber) of the supplier based on team set information from the team view evaluation screen 240.

A specific supplier can be found by typing in the first letter(s) of the supplier's name in the Find Supplier field 214, or by using the scrollbar 215 adjacent the supplier list 211 to arrive at the nearest match. A user can navigate to different screens in the system by using the hyperlink buttons 216 on the left-hand menu section 300 of screen 210. The menu section 300 is repeated in all the subsequent screens.

The team view scores for each supplier in the supplier list 211 may be colored coded to provide a quick visual indication of the supplier's status. For example, If the team view is red the supplier's score is between 0-69.99 indicating poor performance. A team view colored amber corresponds to a score between 70 and 89.99 and indicates average performance. If the team view is green a supplier has a score of greater than 90 indicating above average performance. The actual value ranges for the scores may vary depending upon the situation being evaluated, and the foregoing scores are merely for illustrative purposes. The calculation of evaluation scores is described in detail below.

Homepage screen 210 also has a supplier status report button 217 that, when selected, brings up a supplier status report through which a user can rank the suppliers according to their team view score, in either ascending or descending order, discussed in detail below.

FIG. 6 shows the actuals evaluation screen 220, accessed by selecting the actuals hyperlink button 216 on menu section 300. The actuals evaluation screen 220 contains key performance indicators (KPI) by which suppliers may be measured. Supplier's KPI are viewed by channel (supply chain) either aggregated up to ‘All Suppliers’ or at a supplier, division, or department level. The supplier KPI may include Lateness of Order, Completeness of Order, and Service Level. The Trend button produces a Trend graph plotting Teams View scores overtime. The actuals data may be extracted from an RMS database. The foregoing list of possible KPI is not intended to be inclusive, and other performance indicators may be utilized.

The select channel field 221 provides a list box from which a user can select the supply chain. A select supplier field 222 provides a list of values from which a user may select a single supplier or ‘all suppliers’. The user may enter the first letters of the name and the nearest match will be found, or the scroll bar can be used. The select division field 223 and select department field 224 provide list boxes from which the user may select a division and the department, respectively.

The actuals evaluation screen 220 contains columns of data. The measure column 225 is a listing of the metrics for each supplier. In the illustrated embodiment, the measures include: returns, damaged returns, gross sales, net sales, buying margin, achieved margin, lateness of order, completeness of order, service level, supplier-current level, number of lines sold, annualized sales for the preceding 52 weeks, annualized profit for the preceding 52 weeks, and percentage of supplier turnover.

The second column 226 is a monetary value column. In the illustrated embodiment its monetary unit is pounds. Column 227 is a representation of the percentage of value of the measure. The last column is a units column 228 representing the value in units for the measure in column 224.

Users can indicate how important each metric in column 225 is by assigning an appropriate weight in column 227. One skilled in the art will appreciate that there are a number of different formulas that can be utilized to create an evaluation score. In one embodiment of the invention, the monetary values in column 226 may be multiplied by the corresponding weights in column 227 and the resulting products may be summed together to produce a raw score. The raw scores for each supplier may then be normalized to produce an evaluation score. Of course, one or more of the monetary values in column 227 may also be normalized or otherwise modified before being multiplied by the appropriate weight.

In one embodiment of the invention, each user or a group of users may be given the option of identifying which metrics to score for the suppliers. Furthermore, the user or group of users may be given the option of defining how the metrics will be combined to create an evaluation store. The QA users may designate the metrics to score for the suppliers and the general users will able to enter values for the designated metrics, but will not be able to change the chosen metrics.

By selecting the teams view hyperlink button 216 in menu section 300, teams view evaluation screen 240 is displayed, as shown in FIG. 8. The teams view evaluation screen 240 allows users to view a supplier's performance as evaluated against five defined teams view measures, for both their pre-season and in-season performance, and can be rolled up or down the hierarchy (as in actuals). The five measures in the illustrated embodiment are: deliveries, quality, documentation, culture, and communication. The scores are on a scale of one to ten for each measure, yielding a maximum total score of 100. Trend button 241 brings up a trend graph plotting teams view scores over time. The teams view evaluation screen 240 may also launch an editable version of the page, allowing QA members to create/edit the scores for that supplier at the department level. Score creation/editing can be done by selecting the edit department scores button 242. The five measures are merely intended to be illustrative of possible measures, and other factors may be used as measures of supplier performance.

The select supplier field 222, select division field 223, and select department field 224 are the same as discussed previously with regard to FIG. 6.

The subtotals in fields 243 and 244 are for pre-season and in-season performance, respectively, and the Season total field 245 displays the total score for the supplier. The date the score was created is indicated in date created field 246. The new department button 247 associates a department to a supplier, if association does not already exist. Disassociation is not possible.

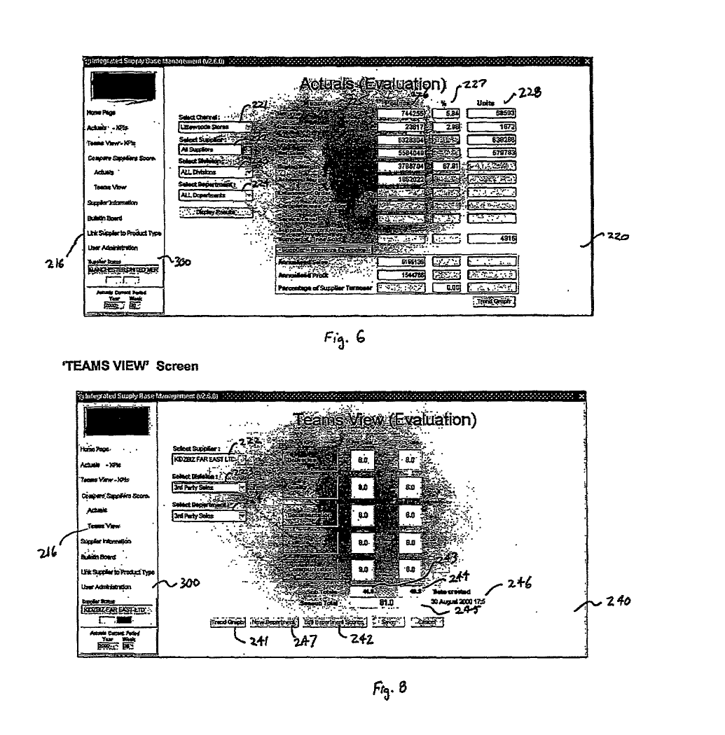

By selecting the supplier information hyperlink button 216 in the side menu 300, a user is presented with supplier information screen 230, shown in FIG. 7. Screen 230 contains a standard form displaying information relating to an individual supplier's contact and reference information. The supplier field 231 provides the name of the supplier. The turnover field 232 indicates the current turnover of the supplier. The website field 233 provides the URL of the selected supplier. Screen 230 may also contain the selected supplier's address, information relating to a contact person, information concerning the selected supplier's factories, and lead-time on orders from each factory. A user can go to the website displayed by clicking on the Go to web-site button 234. The save, reset, edit, ok, and cancel buttons 235-239, respectively, are all for use by specifically authorized personnel.

When a user selects the bulletin board hyperlink button 216 in the side menu 300, the bulletin board screen 250, shown in FIG. 9, is displayed. Screen 250 provides a basis for informal communication for assessing and evaluating the supply base. Users can use the bulletin board screen 250 to create and post a message, and to view messages that have been posted. Thus, the bulletin board screen 250 promotes cross-functional and cross-hierarchical communication, giving users the ability to present information that may not be communicated in the remaining prescribed screens. The bulletin board screen 250 includes a message window 252 that displays the title and subject of a message, and message text, which is the content of the message.

The bulletin board screen 250 is intended to promote cross-functional and cross-hierarchical communication, essentially giving users the ability to present information that may sometimes not be communicated outside of structured information. The bulletin board screen 250 may help facilitate informal communication, quickly spreading news on suppliers who may be struggling financially, quotas which are running out in various areas of the world, news of labour rate shifts, etc. Users who submit messages to the bulletin board screen 250 may define a removal time for the message. Messages may then be automatically removed after this time. The QA users have the ability to view, edit, delete, or publish the messages from the general users.

Referring to FIG. 10, an actuals comparison screen 260 is illustrated. The actuals comparison screen 260 may be selected using the actuals compare suppliers score button 216 in the side menu 300. With the actuals comparison screen 260, a user will be able to compare the actual performance metrics of multiple suppliers by stacking them up next to each other in a matrix. This can be done at department, division or channel level, and comparisons across levels of the hierarchy are possible (i.e. compare supplier A's performance at divisional level against supplier B's performance at company level).

Each supplier is identified in the channel field 261, supplier field 262, division field 263, and department field 264. The measure column 265 corresponds to the measure column 225 in FIG. 6 listing the quantitative KPIs. Similarly, the remaining columns for each supplier parallel the columns in FIG. 6.

The trend evaluation screens 270 and 290, shown in FIGS. 11 and 13, respectively, allows users to see how a supplier has performed over a period of time. For screen 270, the user selects a KPI, for example Culture, Communication, etc. and clicks on the trend graph button 216, shown in FIG. 8, to display a graph in a screen 270. For screen 290, the user selects a KPI, for example Returns, damaged returns, etc. and clicks on the trend graph button 241, shown in FIG. 10, to display a graph in a screen 290.

By selecting the team view comparison button 216 in the side menu 300, the team view comparison screen 280 is displayed, as shown in FIG. 12. The team view comparison screen 280 allows a user to compare the teams view performance metrics of multiple suppliers by stacking them up next to each other in a matrix. Such comparison can be done at department, division or company level, and comparisons across levels of the hierarchy will be possible (i.e. compare supplier A's performance at divisional level against supplier B's performance at company level).

Each supplier is identified by supplier field 281, division field 282, and department field 283. The KPI column 284 corresponds to the five defined teams view measures, for both their pre-season and in-season performance set forth in FIG. 8. In the illustrated embodiment these measures are: deliveries, quality, documentation, culture, and communication. The subtotals are for pre-season and in-season performance, respectively, and the season total field displays the total score for the supplier, as was the case in FIG. 8. The date the score was created is also indicated.

FIG. 14 illustrates a screen 310 for linking a supplier to a product type. Screen 310 is accessed through the link supplier to product type button 216 in the side menu 300, and authorized users to associate a product type with a supplier or add a product type to a suppliers product type list, or delete a product type from the suppliers product type list. From screen 310, users can bring up a report screen, which once a supplier is selected, returns the different product types that the supplier provides.

Screen 310 has two basic fields. A supplier field 312 that includes a list of suppliers, and a product type field 314, that includes a scrolling list from which an authorized user can select a product type to link with a supplier.

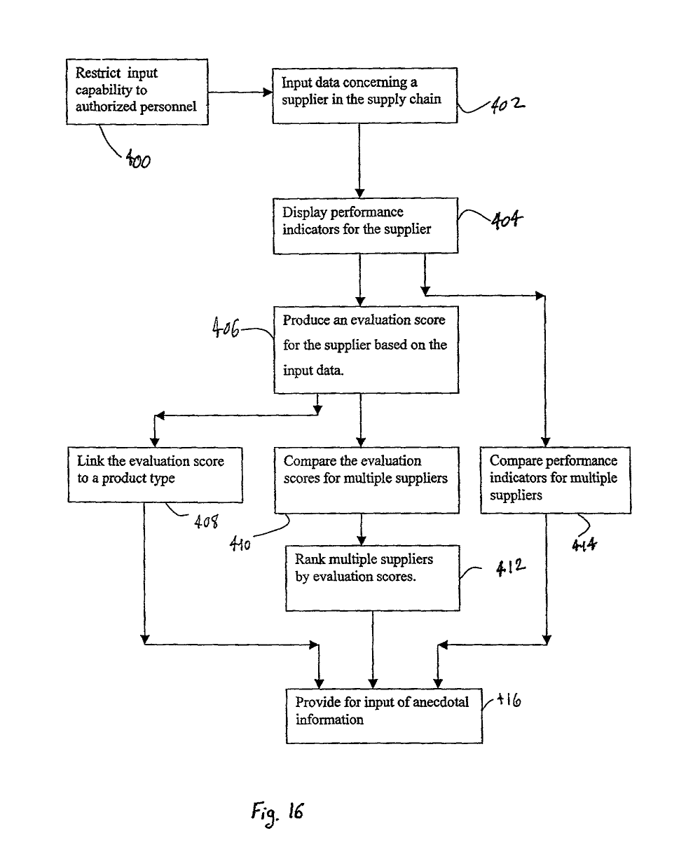

As discussed previously with regard to the homepage screen 210, a supplier status report 320, shown in FIG. 15, may be produced by selecting the status report button 217. The supplier status report 320 allows users to rank the suppliers according to their team view score, in either ascending or descending order.

Referring to FIG. 16, a flow chart of the method for evaluating the supply base according to the present invention is illustrated. In step 400 the QA users can restrict the ability to input supplier data into the system to authorized personnel. Next, in step 402 the data concerning the suppliers is input. Performance indicators for the suppliers are displayed in step 404. An evaluation score is produced in step 406 based upon the input data.

In step 408 the evaluation score produced in step 406 may be linked to a product type. The evaluation scores for multiple suppliers may be compared in step 410 and the performance indicators for multiple suppliers may be compared in step 414. After step 410, multiple suppliers may be ranked according to their evaluation scores, in step 412. Finally, anecdotal information may be input in step 416, and does not have to follow directly from steps 408, 412, or 414. Rather, step 416 may be executed at almost any time in the flow chart shown in FIG. 16.

The illustrated embodiment of the system, method and interface for evaluating the supply base of a supply chain according to the present invention is designed to work with an Oracle® database. However, the present invention is not intended to be limited to Oracle® databases, and may be used with other relational database products such as Jasmine®, Sybase®, Informix®, or PowerBuilder®. The system according to the present invention may request data from the central Oracle Web Server, which will in turn source data from a main Oracle® database. Any time the system is updated the new information is fed back to the central web server and subsequently updates the Oracle® database. The system according to the present invention may be housed in an Oracles database, and may be accessed via a web-browser front end on a LAN using an Oracle® Web Server.

Having described several embodiments of the system and method of optimizing a supply chain in accordance with the present invention, it is believed that other modifications, variations and changes will be suggested to those skilled in the art in view of the description set forth above. It is therefore to be understood that all such variations, modifications and changes are believed to fall within the scope of the invention as defined in the appended claims.

What is claimed is:

1. A method of evaluating the supply base of a supply chain comprising the steps of:
inputting data concerning at least one of multiple suppliers in said supply chain;
displaying performance indicators relating to the performance of said at least one supplier with regard to other entities in said supply chain; and
producing an evaluation score for said at least one supplier based on said inputted data.

2. A method of evaluating the supply base of a supply chain as recited in claim 1, wherein said performance indicators displayed in said displaying step comprise at least one of:
returns, damaged returns group sales, net sales, buying margin, achieved margin, lateness of order, and service level.

3. A method of evaluating the supply base of a supply chain as recited in claim 2, wherein said evaluation score is based upon deliveries, quality, documentation, culture, and communication.

4. A method of evaluating the supply base of a supply chain as recited in claim 3, wherein said evaluation score is based on pre-season and in-season performance.

5. A method of evaluating the supply base of a supply chain as recited in claim 1, wherein said evaluation score is based upon deliveries, quality, documentation, culture, and communication.

6. A method of evaluating the supply base of a supply chain as recited in claim 5, wherein said evaluation score is based on pre-season and in-season performance.

7. A method of evaluating the supply base of a supply chain as recited in claim 1, comprising the further step of comparing said evaluation scores for multiple suppliers.

8. A method of evaluating the supply base of a supply chain as recited in claim 7, wherein said comparison is in tabular form.

9. A method of evaluating the supply base of a supply chain as recited in claim 7, wherein said comparison is in graphical form.

10. A method of evaluating the supply base of a supply chain as recited in claim 1, comprising the further step of comparing said performance indicators for multiple suppliers.

11. A method of evaluating the supply base of a supply chain as recited in claim 7, wherein said performance indicators are displayed in tabular form.

12. A method of evaluating the supply base of a supply chain as recited in claim 7, wherein said performance indicators are displayed in graphical form.

13. A method of evaluating the supply base of a supply chain as recited in claim 1, wherein said evaluation score is a numeric representation of performance.

14. A method of evaluating the supply base of a supply chain as recited in claim 13, wherein said numeric representation is on a scale of 1 to 10.

15. A method of evaluating the supply base of a supply chain as recited in claim 1, wherein said evaluation score is represented in a scale of colors indicating the overall rating of said supplier.

16. A method of evaluating the supply base of a supply chain as recited in claim 1, comprising the further step of providing for input of anecdotal information.

17. A method of evaluating the supply base of a supply chain as recited in claim 1, comprising the further step of linking said evaluation score to a product type.

18. A method of evaluating the supply base of a supply chain as recited in claim 1, comprising the further step of ranking multiple ones of said suppliers by said evaluation scores.

19. A method of evaluating the supply base of a supply chain as recited in claim 1, comprising the further step of restricting said inputting step to authorized personnel.

20. A computer-readable medium having computer-executable instructions for evaluating the supply base of a supply chain performing steps comprising:
accessing data concerning at least one of multiple suppliers in said supply chain;
displaying performance indicators relating to the performance of said at least one supplier with regard to other entities in said supply chain; and
calculating an evaluation score for said at least one supplier based on said accessed data.

21. A computer-readable medium having computer-executable instructions for evaluating the supply base of a supply chain as recited in claim 20, wherein said performance indicators displayed in said displaying step comprise at least one of:
returns, damaged returns group sales, net sales, buying margin, achieved margin, lateness of order, and service level.

22. A computer-readable medium having computer-executable instructions for evaluating the supply base of a supply chain as recited in claim 21, wherein said evaluation score is based upon deliveries, quality, documentation, culture, and communication.

23. A computer-readable medium having computer-executable instructions for evaluating the supply base of a supply chain as recited in claim 22, wherein said evaluation score is based on pre-season and in-season performance.

24. A computer-readable medium having computer-executable instructions for evaluating the supply base of a supply chain as recited in claim 20, wherein said evaluation score is based upon deliveries, quality, documentation, culture, and communication.

25. A computer-readable medium having computer-executable instructions for evaluating the supply base of a supply chain as recited in claim 24, wherein said evaluation score is based on pre-season and in-season performance.

26. A computer-readable medium having computer-executable instructions for evaluating the supply base of a supply chain as recited in claim 20, comprising the further step of comparing said evaluation scores for multiple suppliers.

27. A computer-readable medium having computer-executable instructions for evaluating the supply base of a supply chain as recited in claim 26, wherein said comparison is in tabular form.

28. A computer-readable medium having computer-executable instructions for evaluating the supply base of a supply chain as recited in claim 26, wherein said comparison is in graphical form.

29. A computer-readable medium having computer-executable instructions for evaluating the supply base of a supply chain as recited in claim 20, comprising the further step of comparing said performance indicators for multiple suppliers.

30. A computer-readable medium having computer-executable instructions for evaluating the supply base of a supply chain as recited in claim 26, wherein said performance indicators are displayed in tabular form.

31. A computer-readable medium having computer-executable instructions for evaluating the supply base of a supply chain as recited in claim 26, wherein said performance indicators are displayed in graphical form.

32. A computer-readable medium having computer-executable instructions for evaluating the supply base of a supply chain as recited in claim 20, wherein said evaluation score is a numeric representation of performance.

33. A computer-readable medium having computer-executable instructions for evaluating the supply base of a supply chain as recited in claim 20, wherein said numeric representation is on a scale of 1 to 10.

34. A computer-readable medium having computer-executable instructions for evaluating the supply base of a supply chain as recited in claim 20, wherein said evaluation score is represented in a scale of colors indicating the overall rating of said supplier.

35. A computer-readable medium having computer-executable instructions for evaluating the supply base of a supply chain as recited in claim 20, comprising the further step of providing for input of anecdotal information

36. A computer-readable medium having computer-executable instructions for evaluating the supply base of a supply chain as recited in claim 20, comprising the further step of linking said evaluation score to a product type.

37. A computer-readable medium having computer-executable instructions for evaluating the supply base of a supply chain as recited in claim 20, comprising the further step of ranking multiple ones of said suppliers by said evaluation scores.

38. A computer-readable medium having computer-executable instructions for evaluating the supply base of a supply chain as recited in claim 20, comprising the further step of restricting said inputting step to authorized personnel.

39. A computer-readable medium having computer-executable modules/components for evaluating the supply base of a supply chain, comprising:
a module/component accessing data concerning at least one of multiple suppliers in said supply chain;
a module/component displaying performance indicators relating to the performance of said at least one supplier with regard to other entities in said supply chain; and
a module/component calculating an evaluation score for said at least one supplier based on said accessed data.

40. A computer-readable medium having computer-executable modules/components for evaluating the supply base of a supply chain as recited in claim 39, wherein said performance indicators comprise at least one of:
returns, damaged returns group sales, net sales, buying margin, achieved margin, lateness of order, and service level.

41. A computer-readable medium having computer-executable modules/components for evaluating the supply base of a supply chain as recited in claim 40, wherein said evaluation score is based upon deliveries, quality, documentation, culture, and communication.

42. A computer-readable medium having computer-executable modules/components for evaluating the supply base of a supply chain as recited in claim 41, wherein said evaluation score is based on pre-season and in-season performance.

43. A computer-readable medium having computer-executable modules/components for evaluating the supply base of a supply chain as recited in claim 39, wherein said evaluation score is based upon deliveries, quality, documentation, culture, and communication.

44. A computer-readable medium having computer-executable modules/components for evaluating the supply base of a supply chain as recited in claim 43, wherein said evaluation score is based on pre-season and in-season performance.

45. A computer-readable medium having computer-executable modules/components for evaluating the supply base of a supply chain as recited in claim 39, comprising the further module/component comparing said evaluation scores for multiple suppliers.

46. A computer-readable medium having computer-executable modules/components for evaluating the supply base of a supply chain as recited in claim 45, wherein said comparison is in tabular form.

47. A computer-readable medium having computer-executable modules/components for evaluating the supply base of a supply chain as recited in claim 45, wherein said comparison is in graphical form.

48. A computer-readable medium having computer-executable modules/components for evaluating the supply base of a supply chain as recited in claim 39, comprising the further module/component comparing said performance indicators for multiple suppliers.

49. A computer-readable medium having computer-executable modules/components for evaluating the supply base of a supply chain as recited in claim 45, wherein said performance indicators are displayed in tabular form.

50. A computer-readable medium having computer-executable modules/components for evaluating the supply base of a supply chain as recited in claim 45, wherein said performance indicators are displayed in graphical form.

51. A computer-readable medium having computer-executable modules/components for evaluating the supply base of a supply chain as recited in claim 39, wherein said evaluation score is a numeric representation of performance.

52. A computer-readable medium having computer-executable modules/components for evaluating the supply base of a supply chain as recited in claim 39, wherein said numeric representation is on a scale of 1 to 10.

53. A computer-readable medium having computer-executable modules/components for evaluating the supply base of a supply chain as recited in claim 39, wherein said evaluation score is represented in a scale of colors indicating the overall rating of said supplier.

54. A computer-readable medium having computer-executable modules/components for evaluating the supply base of a supply chain as recited in claim 39, comprising the further module/component providing for input of anecdotal information.

55. A computer-readable medium having computer-executable modules/components for evaluating the supply base of a supply chain as recited in claim 39, comprising the further module component linking said evaluation score to a product type.

56. A computer-readable medium having computer-executable modules/components for evaluating the supply base of a supply chain as recited in claim 39, comprising the further module/component ranking multiple ones of said suppliers by said evaluation scores.

57. A computer-readable medium having computer-executable modules/components for evaluating the supply base of a supply chain as recited in claim 39, comprising the further module/component restricting said inputting step to authorized personnel.

58. A system for evaluating the supply base of a supply chain comprising:
a database of information concerning at least one of multiple suppliers in said supply chain;
an interface displaying performance indicators relating to the performance of said at least one supplier with regard to other entities in said supply chain; and
a processor producing an evaluation score for said at least one supplier based on inputted data.

59. A system for evaluating the supply base of a supply chain as recited in claim 58, wherein said performance indicators displayed in said displaying step comprise at least one of:
returns, damaged returns group sales, net sales, buying margin, achieved margin, lateness of order, and service level.

60. A system for evaluating the supply base of a supply chain as recited in claim 59, wherein said evaluation score is based upon deliveries, quality, documentation, culture, and communication.

61. A system for evaluating the supply base of a supply chain as recited in claim 60, wherein said evaluation score is based on pre-season and in-season performance.

62. A system of evaluating the supply base of a supply chain as recited in claim 58, wherein said evaluation score is based upon deliveries, quality, documentation, culture, and communication.

63. A system of evaluating the supply base of a supply chain as recited in claim 62, wherein said evaluation score is based on pre-season and in-season performance.

64. A system of evaluating the supply base of a supply chain as recited in claim 58, wherein said processor compares said evaluation scores for multiple suppliers.

65. A system of evaluating the supply base of a supply chain as recited in claim 64, wherein said comparison is in tabular form.

66. A system of evaluating the supply base of a supply chain as recited in claim 64, wherein said comparison is in graphical form.

67. A system of evaluating the supply base of a supply chain as recited in claim 58, wherein said processor compares said performance indicators for multiple suppliers.

68. A system of evaluating the supply base of a supply chain as recited in claim 67, wherein said performance indicators are displayed in tabular form.

69. A system of evaluating the supply base of a supply chain as recited in claim 64, wherein said performance indicators are displayed in graphical form.

70. A system of evaluating the supply base of a supply chain as recited in claim 64, wherein said evaluation score is a numeric representation of performance.

71. A system of evaluating the supply base of a supply chain as recited in claim 58, wherein said numeric representation is on a scale of 1 to 10.

72. A system of evaluating the supply base of a supply chain as recited in claim 58, wherein said evaluation score is represented in a scale of colors indicating the overall rating of said supplier.

73. A system of evaluating the supply base of a supply chain as recited in claim 58, wherein anecdotal information can be stored in a memory location for selected suppliers.

74. A system of evaluating the supply base of a supply chain as recited in claim 58, wherein said processor links said evaluation score to a product type.

75. A system of evaluating the supply base of a supply chain as recited in claim 58, wherein said processor ranks multiple ones of said suppliers by said evaluation scores.

76. A system of evaluating the supply base of a supply chain as recited in claim 1, wherein information may only be inputted into said database by authorized personnel.

77. A method of evaluating the supply base of a supply chain as recited in claim 1, comprising the further step of providing a bulletin board so that users may communicate to assess and evaluating the supply base.

78. A method of evaluating the supply base of a supply chain as recited in claim 77, wherein said bulletin board screen facilitates informal communication, quickly spreading news on suppliers.

79. A method of evaluating the supply base of a supply chain as recited in claim 77, comprising the further step of defining a removal time for a message at which time a message will be automatically removed.

80. A method of evaluating the supply base of a supply chain as recited in claim 77, wherein QA users can view, edit, delete, or publish messages posted by general users.

81. A computer-readable medium having computer-executable instructions for evaluating the supply base of a supply chain as recited in claim 20, comprising the further step of providing a bulletin board so that users may communicate to assess and evaluating the supply base.

82. A computer-readable medium having computer-executable instructions for evaluating the supply base of a supply chain as recited in claim 81, wherein said bulletin board screen facilitates informal communication, quickly spreading news on suppliers.

83. A computer-readable medium having computer-executable instructions for evaluating the supply base of a supply chain as recited in claim 81, comprising the further step of defining a removal time for a message at which time a message will be automatically removed.

84. A computer-readable medium having computer-executable instructions for evaluating the supply base of a supply chain as recited in claim 81, wherein QA users can view, edit, delete, or publish messages posted by general users.

85. A computer-readable medium having computer-executable modules/components for evaluating the supply base of a supply chain as recited in claim 39, comprising the further step of providing a bulletin board so that users may communicate to assess and evaluating the supply base.

86. A computer-readable medium having computer-executable modules/components for evaluating the supply base of a supply chain as recited in claim 85, wherein said bulletin board screen facilitates informal communication, quickly spreading news on suppliers.

87. A computer-readable medium having computer-executable modules/components for evaluating the supply base of a supply chain as recited in claim 85, comprising the further step of defining a removal time for a message at which time a message will be automatically removed.

88. A computer-readable medium having computer-executable modules/components for evaluating the supply base of a supply chain as recited in claim 85, wherein QA users can view, edit, delete, or publish messages posted by general users.

89. A system for evaluating the supply base of a supply chain as recited in claim 58, a bulletin board so that users may communicate to assess and evaluating the supply base.

90. A system for evaluating the supply base of a supply chain as recited in claim 89, wherein said bulletin board screen facilitates informal communication, quickly spreading news on suppliers.

91. A system for evaluating the supply base of a supply chain as recited in claim 89, wherein said message to be posted on said bulletin board include a removal time at which time said message will be automatically removed.

92. A system for evaluating the supply base of a supply chain as recited in claim 89, wherein QA users can view, edit, delete, or publish messages posted by general users.

93. A method comprising:
receiving data concerning at least one of a plurality of suppliers;
receiving a request relating to at least one supplier of a supply chain; and
generating at least one performance indicator of the at least one supplier with respect to at least one other supplier.

94. The method as recited in claim 93, further comprising producing an evaluation score for the at least one supplier.

95. A method as recited in claim 93, wherein said at least one performance indicator comprises at least one of:
returns, damaged returns group sales, net sales, buying margin, achieved margin, lateness of order, and service level.

96. A method as recited in claim 93, comprising the further step of producing an evaluation score for said at least one supplier based on said inputted data.

97. A method as recited in claim 96, wherein said evaluation score is based upon deliveries, quality, documentation, culture, and communication.

98. A method as recited in claim 96, wherein said evaluation score is based on preseason and in-season performance.

99. A method as recited in claim 96, wherein said evaluation score is based upon deliveries, quality, documentation, culture, and communication.

100. A method as recited in claim 99, wherein said evaluation score is based on pre-season and in-season performance.

101. A method as recited in claim 96, comprising the further step of comparing said evaluation scores for multiple suppliers.

102. A method as recited in claim 101, wherein said comparison is in tabular form.

103. A method as recited in claim 101, wherein said comparison is in graphical form.

104. A method as recited in claim 93, comprising the further step of comparing said performance indicators for multiple suppliers.

105. A method as recited in claim 101, wherein said performance indicators are in tabular form.

106. A method as recited in claim 101, wherein said performance indicators are in graphical form.

107. A method as recited in claim 96, wherein said evaluation score is a numeric representation of performance.

108. A method as recited in claim 107, wherein said numeric representation is on a scale of 1 to 10.

109. A method as recited in claim 96, wherein said evaluation score is represented in a scale of colors indicating the overall rating of said supplier.

110. A method as recited in claim 93, comprising the further step of providing for input of anecdotal information.

111. A method as recited in claim 93, comprising the further step of linking said evaluation score to a product type.

112. A method as recited in claim 93, comprising the further step of ranking multiple ones of said suppliers by said evaluation scores.

113. A computer-readable medium having computer-executable instructions for evaluating the supply base of a supply chain performing steps comprising:
receiving data concerning at least one of a plurality of suppliers;
receiving a request relating to at least one supplier of a supply chain; and
generating at least one performance indicator of the at least one supplier with respect to at least one other supplier.

114. A computer-readable medium having computer-executable instructions for evaluating the supply base of a supply chain as recited in claim 113, performing a further step comprising producing an evaluation score for the at least one supplier.

115. A computer-readable medium having computer-executable instructions for evaluating the supply base of a supply chain as recited in claim 113, wherein said at least one performance indicator comprises at least one of:
returns, damaged returns group sales, net sales, buying margin, achieved margin, lateness of order, and service level.

116. A computer-readable medium having computer-executable instructions for evaluating the supply base of a supply chain as recited in claim 113, comprising the further step of producing an evaluation score for said at least one supplier based on said inputted data.

117. A computer-readable medium having computer-executable instructions for evaluating the supply base of a supply chain as recited in claim 116, wherein said evaluation score is based upon deliveries, quality, documentation, culture, and communication.

118. A computer-readable medium having computer-executable instructions for evaluating the supply base of a supply chain as recited in claim 116, wherein said evaluation score is based on pre-season and in-season performance.

119. A computer-readable medium having computer-executable instructions for evaluating the supply base of a supply chain as recited in claim 116, wherein said evaluation score is based upon deliveries, quality, documentation, culture, and communication.

120. A computer-readable medium having computer-executable instructions for evaluating the supply base of a supply chain as recited in claim 119, wherein said evaluation score is based on pre-season and in-season performance.

121. A computer-readable medium having computer-executable instructions for evaluating the supply base of a supply chain as recited in claim 116, comprising the further step of comparing said evaluation scores for multiple suppliers.

122. A computer-readable medium having computer-executable instructions for evaluating the supply base of a supply chain as recited in claim 121, wherein said comparison is in tabular form.

123. A computer-readable medium having computer-executable instructions for evaluating the supply base of a supply chain as recited in claim 121, wherein said comparison is in graphical form.

124. A computer-readable medium having computer-executable instructions for evaluating the supply base of a supply chain as recited in claim 113, comprising the further step of comparing said performance indicators for multiple suppliers.

125. A computer-readable medium having computer-executable instructions for evaluating the supply base of a supply chain as recited in claim 121, wherein said performance indicators are in tabular form.

126. A computer-readable medium having computer-executable instructions for evaluating the supply base of a supply chain as recited in claim 121, wherein said performance indicators are in graphical form.

127. A computer-readable medium having computer-executable instructions for evaluating the supply base of a supply chain as recited in claim 116, wherein said evaluation score is a numeric representation of performance.

128. A computer-readable medium having computer-executable instructions for evaluating the supply base of a supply chain as recited in claim 127, wherein said numeric representation is on a scale of 1 to 10.

129. A computer-readable medium having computer-executable instructions for evaluating the supply base of a supply chain as recited in claim 116, wherein said evaluation score is represented in a scale of colors indicating the overall rating of said supplier.

130. A computer-readable medium having computer-executable instructions for evaluating the supply base of a supply chain as recited in claim 113, comprising the further step of providing for input of anecdotal information.

131. A computer-readable medium having computer-executable instructions for evaluating the supply base of a supply chain as recited in claim 113, comprising the further step of linking said evaluation score to a product type.

132. A computer-readable medium having computer-executable instructions for evaluating the supply base of a supply chain as recited in claim 113, comprising the further step of ranking multiple ones of said suppliers by said evaluation scores.

133 A computer-readable medium having computer-executable modules/components for evaluating the supply base of a supply chain, comprising:
a module/component receiving data concerning at least one of a plurality of suppliers;
a module/component receiving a request relating to at least one supplier of a supply chain; and
a module/component generating at least one performance indicator of the at least one supplier with respect to at least one other supplier.

134. A computer-readable medium having computer-executable modules/components for evaluating the supply base of a supply chain, as recited in claim 133, further comprising a module/component producing an evaluation score for the at least one supplier.

135. A computer-readable medium having computer-executable modules/components for evaluating the supply base of a supply chain as recited in claim 133, wherein said at least one performance indicator comprises at least one of:
returns, damaged returns group sales, net sales, buying margin, achieved margin, lateness of order, and service level.

136. A computer-readable medium having computer-executable modules/components for evaluating the supply base of a supply chain as recited in claim 133, further comprising a module/component producing an evaluation score for said at least one supplier based on said inputted data.

137. A computer-readable medium having computer-executable modules/components for evaluating the supply base of a supply chain as recited in claim 136, wherein said evaluation score is based upon deliveries, quality, documentation, culture, and communication.

138. A computer-readable medium having computer-executable modules/components for evaluating the supply base of a supply chain as recited in claim 136, wherein said evaluation score is based on pre-season and in-season performance.

139. A computer-readable medium having computer-executable modules/components for evaluating the supply base of a supply chain as recited in claim 136, wherein said evaluation score is based upon deliveries, quality, documentation, culture, and communication.

140. A computer-readable medium having computer-executable modules/components for evaluating the supply base of a supply chain as recited in claim 139, wherein said evaluation score is based on pre-season and in-season performance.

141. A computer-readable medium having computer-executable modules/components for evaluating the supply base of a supply chain as recited in claim 136, further comprising a module/component comparing said evaluation scores for multiple suppliers.

142. A computer-readable medium having computer-executable modules/components for evaluating the supply base of a supply chain as recited in claim 141, wherein said comparison is in tabular form.

143. A computer-readable medium having computer-executable modules/components for evaluating the supply base of a supply chain as recited in claim 141, wherein said comparison is in graphical form.

144. A computer-readable medium having computer-executable modules/components for evaluating the supply base of a supply chain as recited in claim 133, further comprising a module/component comparing said performance indicators for multiple suppliers.

145. A computer-readable medium having computer-executable modules/components for evaluating the supply base of a supply chain as recited in claim 141, wherein said performance indicators are in tabular form.

146. A computer-readable medium having computer-executable modules/components for evaluating the supply base of a supply chain as recited in claim 141, wherein said performance indicators are in graphical form.

147. A computer-readable medium having computer-executable modules/components for evaluating the supply base of a supply chain as recited in claim 136, wherein said evaluation score is a numeric representation of performance.

148. A computer-readable medium having computer-executable modules/components for evaluating the supply base of a supply chain as recited in claim 147, wherein said numeric representation is on a scale of 1 to 10.

149. A computer-readable medium having computer-executable modules/components for evaluating the supply base of a supply chain as recited in claim 136, wherein said evaluation score is represented in a scale of colors indicating the overall rating of said supplier.

150. A computer-readable medium having computer-executable modules/components for evaluating the supply base of a supply chain as recited in claim 133, further comprising a module/component providing for input of anecdotal information.

151. A computer-readable medium having computer-executable modules/components for evaluating the supply base of a supply chain as recited in claim 133, further comprising a module/component linking said evaluation score to a product type.

152. A computer-readable medium having computer-executable modules/components for evaluating the supply base of a supply chain as recited in claim 133, further comprising a module/component ranking multiple ones of said suppliers by said evaluation scores.

153. A method comprising:
logging into a system that contains data concerning suppliers of a supply chain;
sending a request for performance information concerning the suppliers;
receiving the performance information; and
evaluating the suppliers based on the performance information.

154. A method of claim 153, wherein the performance information includes at least one of actuals evaluations, supplier information, teams view evaluations and bulletin board data.

155. A method as recited in claim 153, further comprising producing an evaluation score for the at least one supplier.

156. A method as recited in claim 154, wherein said performance information comprises at least one of:
returns, damaged returns group sales, net sales, buying margin, achieved margin, lateness of order, and service level.

157. A method as recited in claim 154, comprising the further step of producing an evaluation score for said at least one supplier based on said inputted data.

158. A method as recited in claim 157, wherein said evaluation score is based upon deliveries, quality, documentation, culture, and communication.

159. A method as recited in claim 157, wherein said evaluation score is based on pre-season and in-season performance.

160. A method as recited in claim 157, wherein said evaluation score is based upon deliveries, quality, documentation, culture, and communication.

161. A method as recited in claim 160, wherein said evaluation score is based on pre-season and in-season performance.

162. A method as recited in claim 157, comprising the further step of comparing said evaluation scores for multiple suppliers.

163. A method as recited in claim 162, wherein said comparison is in tabular form.

164. A method as recited in claim 162, wherein said comparison is in graphical form.

165. A method as recited in claim 154, comprising the further step of comparing said performance information for multiple suppliers.

166. A method as recited in claim 162, wherein said performance information is in tabular form.

167. A method as recited in claim 162, wherein said performance in formation is in graphical form.

168. A method as recited in claim 157, wherein said evaluation score is a numeric representation of performance.

169. A method as recited in claim 168, wherein said numeric representation is on a scale of 1 to 10.

170. A method as recited in claim 157, wherein said evaluation score is represented in a scale of colors indicating the overall rating of said supplier.

171. A method as recited in claim 154, comprising the further step of providing for input of anecdotal information.

172. A method as recited in claim 154, comprising the further step of linking said evaluation score to a product type.

173. A method as recited in claim 154, comprising the further step of ranking multiple ones of said suppliers by said evaluation scores.

174. A computer-readable medium having computer-executable instructions for evaluating the supply base of a supply chain performing steps comprising:
logging into a system that contains data concerning suppliers of a supply chain;
sending a request for performance information concerning the suppliers;
receiving the performance information; and
evaluating the suppliers based on the performance information.

175. A computer-readable medium having computer-executable instructions for evaluating the supply base of a supply chain as recited in claim 174, performing a further step comprising producing an evaluation score for the at least one supplier.

176. A computer-readable medium having computer-executable instructions for evaluating the supply base of a supply chain as recited in claim 174, wherein said performance information comprises at least one of:
returns, damaged returns group sales, net sales, buying margin, achieved margin, lateness of order, and service level.

177. A computer-readable medium having computer-executable instructions for evaluating the supply base of a supply chain as recited in claim 174, comprising the further step of producing an evaluation score for said at least one supplier based on said inputted data.

178. A computer-readable medium having computer-executable instructions for evaluating the supply base of a supply chain as recited in claim 177, wherein said evaluation score is based upon deliveries, quality, documentation, culture, and communication.

179. A computer-readable medium having computer-executable instructions for evaluating the supply base of a supply chain as recited in claim 177, wherein said evaluation score is based on pre-season and in-season performance.

180. A computer-readable medium having computer-executable instructions for evaluating the supply base of a supply chain as recited in claim 177, wherein said evaluation score is based upon deliveries, quality, documentation, culture, and communication.

181. A computer-readable medium having computer-executable instructions for evaluating the supply base of a supply chain as recited in claim 180, wherein said evaluation score is based on pre-season and in-season performance.

182. A computer-readable medium having computer-executable instructions for evaluating the supply base of a supply chain as recited in claim 177, comprising the further step of comparing said evaluation scores for multiple suppliers.

183. A computer-readable medium having computer-executable instructions for evaluating the supply base of a supply chain as recited in claim 182, wherein said comparison is in tabular form.

184. A computer-readable medium having computer-executable instructions for evaluating the supply base of a supply chain as recited in claim 182, wherein said comparison is in graphical form.

185. A computer-readable medium having computer-executable instructions for evaluating the supply base of a supply chain as recited in claim 174, comprising the further step of comparing said performance information for multiple suppliers.

186. A computer-readable medium having computer-executable instructions for evaluating the supply base of a supply chain as recited in claim 182, wherein said performance information is in tabular form.

187. A computer-readable medium having computer-executable instructions for evaluating the supply base of a supply chain as recited in claim 182, wherein said performance information is in graphical form.

188. A computer-readable medium having computer-executable instructions for evaluating the supply base of a supply chain as recited in claim 177, wherein said evaluation score is a numeric representation of performance.

189. A computer-readable medium having computer-executable instructions for evaluating the supply base of a supply chain as recited in claim 188, wherein said numeric representation is on a scale of 1 to 10.

190. A computer-readable medium having computer-executable instructions for evaluating the supply base of a supply chain as recited in claim 177, wherein said evaluation score is represented in a scale of colors indicating the overall rating of said supplier.

191. A computer-readable medium having computer-executable instructions for evaluating the supply base of a supply chain as recited in claim 174, comprising the further step of providing for input of anecdotal information.

192. A computer-readable medium having computer-executable instructions for evaluating the supply base of a supply chain as recited in claim 174, comprising the further step of linking said evaluation score to a product type.

193. A computer-readable medium having computer-executable instructions for evaluating the supply base of a supply chain as recited in claim 174, comprising the further step of ranking multiple ones of said suppliers by said evaluation scores.

194. A computer-readable medium having computer-executable modules/components for evaluating the supply base of a supply chain, comprising:
a module/component logging into a system that contains data concerning suppliers of a supply chain;
a module/component sending a request for performance information concerning the suppliers;
a module/component receiving the performance information; and
a module/component evaluating the suppliers based on the performance information.

195. A computer-readable medium having computer-executable modules/components for evaluating the supply base of a supply chain, as recited in claim 194, further comprising a module/component producing an evaluation score for the at least one supplier.

196. A computer-readable medium having computer-executable modules/components for evaluating the supply base of a supply chain as recited in claim 195, wherein said performance information comprises at least one of:
returns, damaged returns group sales, net sales, buying margin, achieved margin, lateness of order, and service level.

197. A computer-readable medium having computer-executable modules/components for evaluating the supply base of a supply chain as recited in claim 196, further comprising a module/component producing an evaluation score for said at least one supplier based on said inputted data.

198. A computer-readable medium having computer-executable modules/components for evaluating the supply base of a supply chain as recited in claim 197, wherein said evaluation score is based upon deliveries, quality, documentation, culture, and communication.

199. A computer-readable medium having computer-executable modules/components for evaluating the supply base of a supply chain as recited in claim 197, where in said evaluation score is based on pre-season and in-season performance.

200. A computer-readable medium having computer-executable modules/components for evaluating the supply base of a supply chain as recited in claim 197, wherein said evaluation score is based upon deliveries, quality, documentation, culture, and communication.

201. A computer-readable medium having computer-executable modules/components for evaluating the supply base of a supply chain as recited in claim 200, wherein said evaluation score is based on pre-season and in-season performance.

202. A computer-readable medium having computer-executable modules/components for evaluating the supply base of a supply chain as recited in claim 197, further comprising a module/component comparing said evaluation scores for multiple suppliers.

203. A computer-readable medium having computer-executable modules/components for evaluating the supply base of a supply chain as recited in claim 202, wherein said comparison is in tabular form.

204. A computer-readable medium having computer-executable modules/components for evaluating the supply base of a supply chain as recited in claim 202, wherein said comparison is in graphical form.

205. A computer-readable medium having computer-executable modules/components for evaluating the supply base of a supply chain as recited in claim 194, further comprising a module/component comparing said performance information for multiple suppliers.

206. A computer-readable medium having computer-executable modules/components for evaluating the supply base of a supply chain as recited in claim 202, wherein said performance information is in tabular form.

207. A computer-readable medium having computer-executable modules/components for evaluating the supply base of a supply chain as recited in claim 202, wherein said performance information is in graphical form.

208. A computer-readable medium having computer-executable modules/components for evaluating the supply base of a supply chain as recited in claim 197, wherein said evaluation score is a numeric representation of performance.

209. A computer-readable medium having computer-executable modules/components for evaluating the supply base of a supply chain as recited in claim 208, wherein said numeric representation is on a scale of 1 to 10.

210. A computer-readable medium having computer-executable modules/components for evaluating the supply base of a supply chain as recited in claim 197, wherein said evaluation score is represented in a scale of colors indicating the overall rating of said supplier.

211. A computer-readable medium having computer-executable modules/components for evaluating the supply base of a supply chain as recited in claim 194, further comprising a module/component providing for input of anecdotal information.

212. A computer-readable medium having computer-executable modules/components for evaluating the supply base of a supply chain as recited in claim 194, further comprising a module/component linking said evaluation score to a product type.

213. A computer-readable medium having computer-executable modules/components for evaluating the supply base of a supply chain as recited in claim 194, further comprising a module/component ranking multiple ones of said suppliers by said evaluation scores.
